(19) United States
(12) Patent Application Publication
(10) Pub. No.: US 2025/0006387 A1
(43) Pub. Date: Jan. 2, 2025

(54) EXTERNAL THERMAL INSULATION FOR A NUCLEAR REACTOR VESSEL AND SYSTEM FOR INSTALLING SAME

(71) Applicants: JOINT STOCK COMPANY 'ROSENERGOATOM', Moscow (RU); SCIENCE AND INNOVATIONS - NUCLEAR INDUSTRY SCIENTIFIC DEVELOPMENT PRIVATE ENTER, Moscow (RU)

(72) Inventors: TIMUR MARATOVICH GABAIDULOV, Moscow (RU); SERGEI VLADIMIROVICH IL'YIN, Moscow (RU); IGOR EVGEN'EVICH ZHUK, Moscow (RU); VLADIMIR VASIL'EVICH MARKIN, Moscow (RU)

(73) Assignees: JOINT STOCK COMPANY 'ROSENERGOATOM', Moscow (RU); SCIENCE AND INNOVATIONS - NUCLEAR INDUSTRY SCIENTIFIC DEVELOPMENT PRIVATE ENTER, Moscow (RU)

(21) Appl. No.: 17/619,119

(22) PCT Filed: Jan. 24, 2020
(86) PCT No.: PCT/RU2020/000029

§ 371 Date: Dec. 14, 2021

(30) Foreign Application Priority Data
Dec. 3, 2019 (RU) 2019139212

(51) Int. Cl. B66F 9/065; B61C 13/00; G21C 11/08

(52) U.S. Cl. CPC B66F 9/065; G21C 11/081; B61C 13/00

(57) ABSTRACT

The group of invention refers to the area of nuclear power engineering, particularly to auxiliary devices for nuclear power plants, namely to the devices for installation of the outer heat insulation of a nuclear reactor vessel, and can be used at nuclear plants for recovery annealing of welds and/or base metal of the VVER reactor pressure vessel. The task to be solved by the claimed group of inventions is to ensure the installation and disassembly of heat insulation of the outer surface of the VVER reactor pressure vessel in the confined space under the reactor and with the high level of ionizing radiation, as well as work performance in an automated mode, which excludes the exposure of personnel to ionizing radiation.

The technical result of the invention related to outer heat insulation of the nuclear reactor pressure vessel is the reduction of the temperature gradient through the thickness of the nuclear reactor vessel by heat insulation of the external reactor vessel surface, assurance of uniform physical properties for the reactor vessel metal and welds, and reduction of thermal impacts on the surrounding structures during recovery annealing of the welds and/or base metal of the VVER reactor vessel.

The technical result of the invention is provided by the fact that the external heat insulation of the nuclear reactor pressure vessel includes racks, supporting and heat insulation rings installed in series above each other on the upper support platforms of the racks and covering the nuclear reactor pressure vessel, with the racks evenly placed under the supporting and heat insulation rings on the floor of the space under reactor, each rack is provided with guide channels made on the upper part of the inner surface of the rack, and pivoted on the rack base, while the joint between the rack and the rack base is offset relative to the center of gravity of the rack with the possibility of deflection of the rack from the vertical position and its self-return to the vertical position, and the rack base is equipped with an adjustable screw support and has a support platform. Primarily supporting and heat insulation rings are made in the form of articulated sections of frame structure, made in the form of arched ring segments; heat insulation made of mullite-silica felt is fixed on the inner side of the frame of each heat insulation ring section; heat insulation blocks made in the form of triangular sheet piles of mullite-silica felt are additionally fixed on the upper surface of the upper heat insulation ring sections; support casings are made on the outer side of the frame of the support and heat insulation ring sections adjacent to the racks.

The technical result of the invention related to the system of installation for outer heat insulation of the nuclear reactor pressure vessel is ensuring installation in confined spaces under the reactor and at elevated ionizing radiation level, reduction of the temperature gradient through the thickness of the nuclear reactor vessel by heat insulation of the external reactor vessel surface, assurance of uniform physical properties for the reactor vessel metal and welds, and reduction of thermal impacts on the surrounding structures during recovery annealing of the welds and/or base metal of the VVER reactor pressure vessel. The specified technical result is achieved by the fact that the system for the installation of outer reactor vessel heat insulation includes outer heat insulation of the nuclear reactor vessel, hoists and mobile shuttle with replacement mounting equipment; at the same time, the outer nuclear reactor vessel heat insulation contains racks mounted on the floor of the space under the reactor, supporting and heat insulation rings installed in series on top of each other on the upper support platforms of the racks and enveloping the nuclear reactor vessel; the mobile shuttle is equipped with a mechanism for controlling the replacement mounting equipment and the shuttle travel drive, a limit switch for the mobile shuttle, a pumping station and a hydraulic jack placed in the center of the shuttle with a swiveling disc fixed to the jack rod, connected to the pumping station; and the replacement mounting equipment includes a device for mounting racks, a device for mounting elevators and a device for mounting support and heat insulating rings. The system of outer reactor vessel heat insulation installation primarily includes four racks evenly mounted under the support and heat insulation rings on the floor of the space under the reactor; each rack is provided with guide channels made on the upper part of the inner rack surface, and is hinged to the rack base, with the joint of the rack and the rack base shifted relative to the center of gravity of the rack, allowing the rack to deviate from the vertical position and to self-return to the vertical position; and the rack base is equipped with an adjustable screw support and grip brackets for articulation with the rack mounting device, and has a support platform for the installation of elevators. Support and heat insulation rings of the outer nuclear reactor pressure vessel heat insulation can be made in the form of articulated sections of frame structure, made in the form of arched segments of the ring, that enable folding the ring in a rectilinear-extended transport position and its unfolding in the form of a circle in the working position; heat insulation made of mullite-silica felt is fixed on the inner side of the frame of each section of the heat insulation ring; heat insulation blocks made in the form of triangular sheet piles of mullite-silica felt can be additionally fixed on the upper surface of the upper heat insulation ring sections for the heat insulation of the support truss of the reactor pressure vessel, support casings can be made on the outer side of the frame of support and heat insulation rings' sections adjacent to the racks, interacting when mounting the rings with the guide channels of the racks; and bushings for the articulation with pins of the support and heat insulating rings installation device can be made outside on the frame of the sections diametrically opposed in the working position of the ring and being the first and last sections in the transport position of the ring, as well as on the frame of two side sections opposed in the transport position of the ring. Rack mounting device primarily includes a swiveling frame fixed on the swiveling disc of the hydraulic jack of the shuttle, equipped with a hydraulic rotary mechanism, safety catches fixed at the ends of the frame designed for articulation with the grip brackets of the rack bases, and bars designed for holding the racks. Elevator mounting device primarily includes rotary beams equipped with a separation mechanism; there are supporting hubs in the middle part of the rotary beams, that can rotate on a swivel disc of a hydraulic jack; there are hydraulic elevators fixed at the ends of the rotary beams, designed for installation of supporting and insulation rings; and there are beam decks for laying of supporting and insulation rings fixed on the rotary beams. The device for installation of supporting and insulating rings primarily contains a frame with decking designed for laying of supporting or insulating ring; at the end of the frame there are vertical pins designed for articulation with bushings of the first ring section in the transport position of the ring, at the opposite end of the frame there is a mobile carriage with a traveling mechanism, which has vertical pins for articulation with bushings of the last ring section in the transport position; and in the middle part of the frame, there are hydraulic cylinders designed for extending the two opposed side sections in the transport position of the ring, the ends of hydraulic cylinders' rods have vertical pins for articulation with the bushings of the ring side sections. The wheel pairs of the shuttle are primarily installed on the rail track laid under the reactor, the shuttle can be equipped with a locking mechanism, and one wheel pair of the shuttle can be driven. The control mechanism for the replacement mounting equipment and the shuttle travel drive primarily contains a control cabinet electrically connected with the shuttle travel drive, the shuttle travel limit switch, the shuttle pump station, the hydraulic jack of the shuttle and the hydraulic cylinders of the removable mounting equipment. The hydraulic cylinders of replacement mounting equipment can be hydraulically connected to the shuttle pump station in the operating position. The outer nuclear reactor vessel insulation installation system can be equipped with hydraulic cylinders for deflecting the racks when removing the support and heat insulation rings, installed on the ends of rotary beams or on elevators.

The group of invention refers to the area of nuclear power engineering, particularly to auxiliary devices for nuclear power plants, namely to the devices for installation of the outer heat insulation of a nuclear reactor vessel, and can be used at nuclear plants for recovery annealing of welds and/or base metal of the VVER reactor pressure vessel.

No devices for installation of the outer heat insulation of a nuclear reactor pressure vessel are known from the prior art.

The task to be solved by the claimed group of inventions is to ensure the installation and disassembly of heat insulation of the outer surface of the VVER reactor pressure vessel in the confined space under the reactor and with the high level of ionizing radiation, as well as work performance in an automated mode, which excludes the exposure of personnel to ionizing radiation.

The technical result of the invention related to outer heat insulation of the nuclear reactor pressure vessel is the reduction of the temperature gradient through the thickness of the nuclear reactor vessel by heat insulation of the external reactor vessel surface, assurance of uniform physical properties for the reactor vessel metal and welds, and reduction of thermal impacts on the surrounding structures during recovery annealing of the welds and/or base metal of the VVER reactor vessel.

The technical result of the invention is provided by the fact that the external heat insulation of the nuclear reactor pressure vessel includes racks, supporting and heat insulation rings installed in series above each other on the upper support platforms of the racks and covering the nuclear reactor pressure vessel, with the racks evenly placed under the supporting and heat insulation rings on the floor of the space under reactor, each rack is provided with guide channels made on the upper part of the inner surface of the rack, and pivoted on the rack base, while the joint between the rack and the rack base is offset relative to the center of gravity of the rack with the possibility of deflection of the rack from the vertical position and its self-return to the vertical position, and the rack base is equipped with an adjustable screw support and has a support platform.

Primarily, the support and heat insulation rings are made in the form of articulated sections of frame structure, made in the form of arched ring segments, heat insulation, made of mullite-silica felt is fixed on the inner side of the frame of each section of the heat insulation ring, heat insulation rollers made of mullite-silica felt are additionally fixed on the upper surface of the upper insulation ring sections, and support casings are made on the outer side of the frame of the support and insulation ring sections adjacent to the racks.

The technical result of the invention related to the system of installation for outer heat insulation of the nuclear reactor pressure vessel is ensuring installation in confined spaces under the reactor and at elevated ionizing radiation level, reduction of the temperature gradient through the thickness of the nuclear reactor vessel by heat insulation of the external reactor vessel surface, assurance of uniform physical properties for the reactor vessel metal and welds, and reduction of thermal impacts on the surrounding structures during recovery annealing of the welds and/or base metal of the VVER reactor vessel and exposure of operating personnel to ionizing radiation.

The specified technical result relating to the system of installing for outer heat insulation of the reactor pressure vessel is achieved by the fact that the system includes outer heat insulation for the reactor pressure vessel, elevators and a mobile shuttle with replacement mounting equipment, with the external heat insulation of the reactor pressure vessel containing racks mounted on the floor of the space under the reactor, support and heat insulation rings, installed in series over each other on the upper support platforms of the racks and enveloping the reactor pressure vessel; the mobile shuttle is equipped with a mechanism for controlling the replacement mounting equipment and the shuttle travel drive, limit switch of the shuttle travel, a pumping station and a hydraulic jack connected to the pumping station placed in the center of the shuttle, with a rotating disk fixed to the jack rod, and the replacement mounting equipment includes a rack mounting device, a device for mounting the elevators and a device for mounting the support and heat insulation rings.

The system of outer reactor vessel heat insulation installation primarily includes four racks evenly mounted under the support and heat insulation rings on the floor of the space under the reactor; each rack is provided with guide channels made on the upper part of the inner rack surface, and is hinged to the rack base, with the joint of the rack and the rack base shifted relative to the center of gravity of the rack, allowing the rack to deviate from the vertical position and to self-return to the vertical position; and the rack base is equipped with an adjustable screw support and grip brackets for articulation with the rack mounting device, and has a support platform for the installation of elevators.

Support and heat insulation rings of the outer nuclear reactor pressure vessel heat insulation can be made in the form of articulated sections of frame structure, made in the form of arched segments of the ring, that enable folding the ring in a rectilinear-extended transport position and its unfolding in the form of a circle in the working position; heat insulation made of mullite-silica felt is fixed on the inner side of the frame of each section of the heat insulation ring, heat insulation rollers made of mullite-silica felt, which serving for heat insulation of the support truss of the nuclear reactor vessel, can be additionally fixed on the upper surface of the sections of the upper heat insulation ring; support casings can be made on the outer side of the frame of support and heat insulation rings' sections adjacent to the racks, interacting when mounting the rings with the guide channels of the racks; and bushings for the articulation with pins of the support and heat insulating rings installation device can be made outside on the frame of the sections diametrically opposed in the working position of the ring and being the first and last sections in the transport position of the ring, as well as on the frame of two side sections opposed in the transport position of the ring.

Rack mounting device primarily includes a swiveling frame fixed on the swiveling disc of the hydraulic jack of the shuttle, equipped with a hydraulic rotary mechanism, safety catches fixed at the ends of the frame designed for articulation with the grip brackets of the rack bases, and bars designed for holding the racks.

Elevator mounting device primarily includes rotary beams equipped with a separation mechanism; there are supporting hubs in the middle part of the rotary beams, that can rotate on a swivel disc of a hydraulic jack; there are hydraulic elevators fixed at the ends of the rotary beams, designed for installation of supporting and insulation rings; and there are beam decks for laying of supporting and insulation rings fixed on the rotary beams.

The device for installation of supporting and insulating rings primarily contains a frame with decking designed for laying of supporting or insulating ring; at the end of the frame, there are vertical pins designed for articulation with bushings of the first ring section in the transport position of the ring; at the opposite end of the frame, there is a mobile carriage with a traveling mechanism, which has vertical pins for articulation with bushings of the last ring section in the transport position; and in the middle part of the frame, there are hydraulic cylinders designed for the separation the two opposed side sections in the transport position of the ring, the ends of hydraulic cylinders' rods have vertical pins for articulation with the bushings of the ring side sections.

The wheel pairs of the shuttle are primarily installed on the rail track laid under the reactor, the shuttle can be equipped with a locking mechanism, and one wheel pair of the shuttle can be driven.

The control mechanism for the replacement mounting equipment and the shuttle travel drive primarily contains a control cabinet electrically connected with the shuttle travel drive, the shuttle travel limit switch, the shuttle pump station, the hydraulic jack of the shuttle and the hydraulic cylinders of the removable mounting equipment.

The hydraulic cylinders of replacement mounting equipment can be hydraulically connected to the shuttle pump station in the operating position.

The system of outer reactor vessel heat insulation installation can be equipped with hydraulic cylinders for deflecting the racks when disassembling the support and heat insulation rings, installed on the ends of the rotating beams or on elevators.

The claimed group of inventions is explained by drawings and presented in a configuration, where

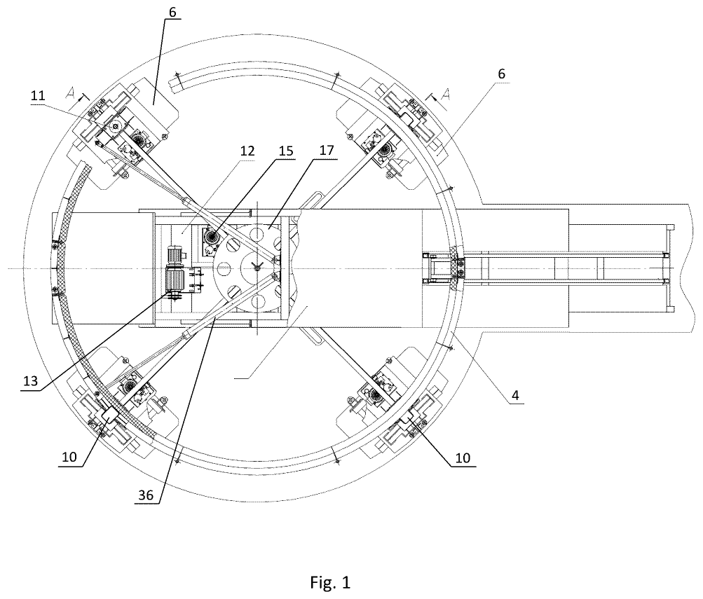

FIG. 1 shows a general diagram of the system (top view),

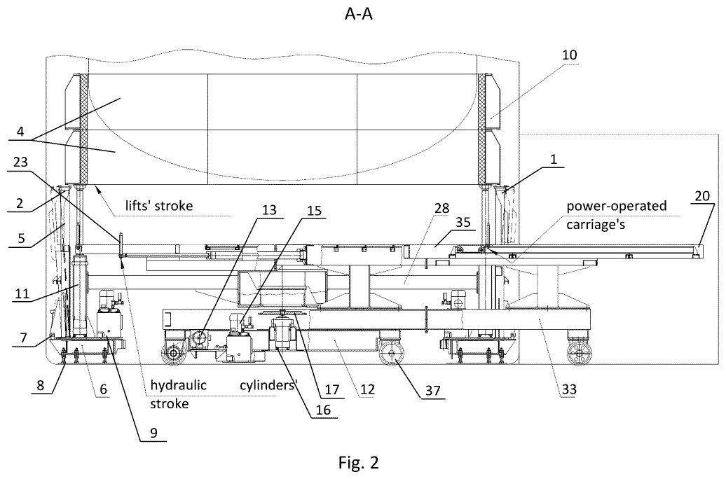

FIG. 2 shows side view of the system,

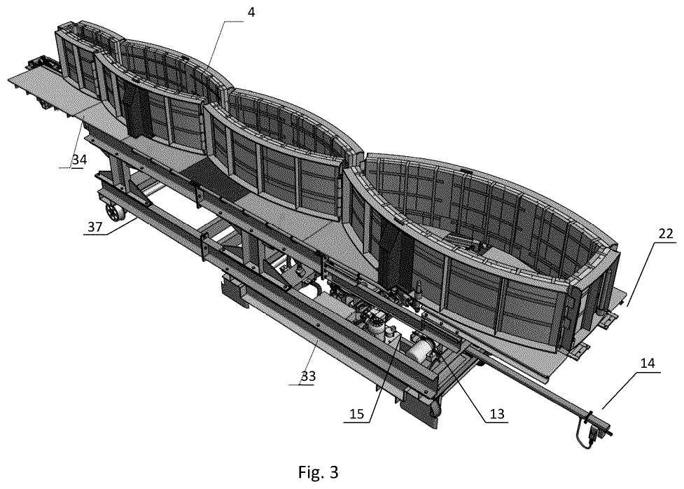

FIG. 3 shows general view of the shuttle with a heat insulating ring,

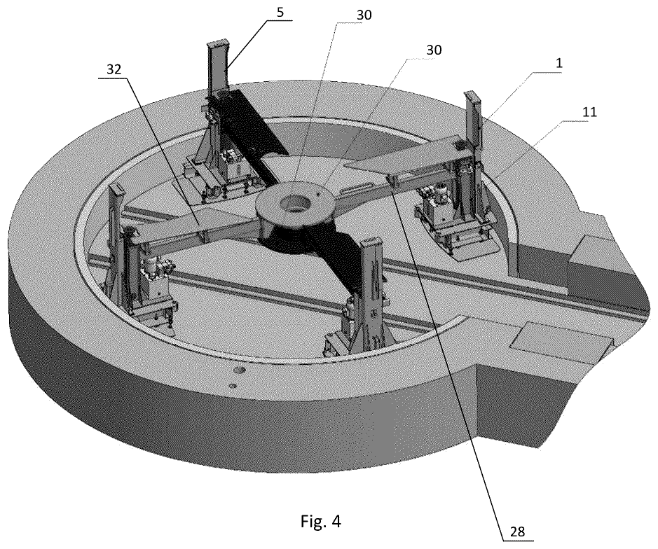

FIG. 4 shows general view of racks installed under the reactor with hoists and rotary tanks;

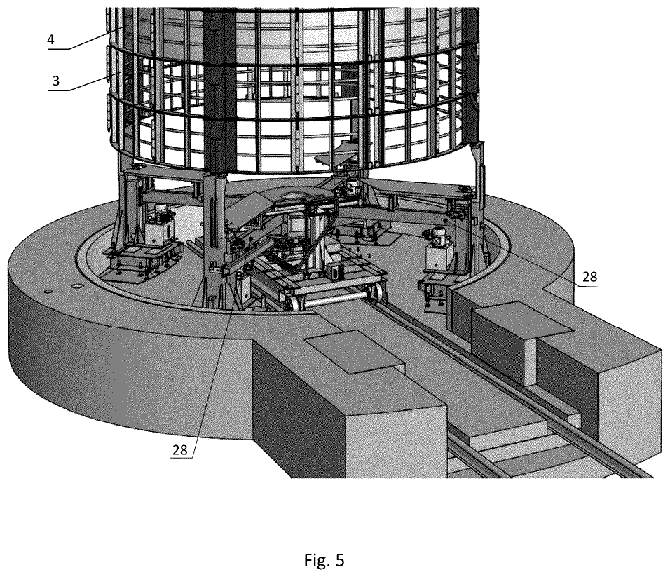

FIG. 5 shows general view of the system with the installed support and heat insulation rings of the reactor vessel outer heat insulation;

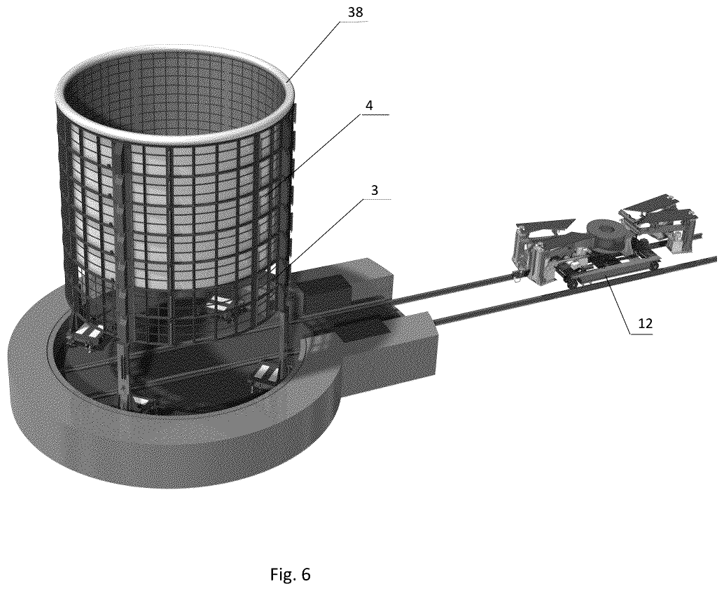

FIG. 6 shows general view of the reactor vessel outer heat insulation and the shuttle;

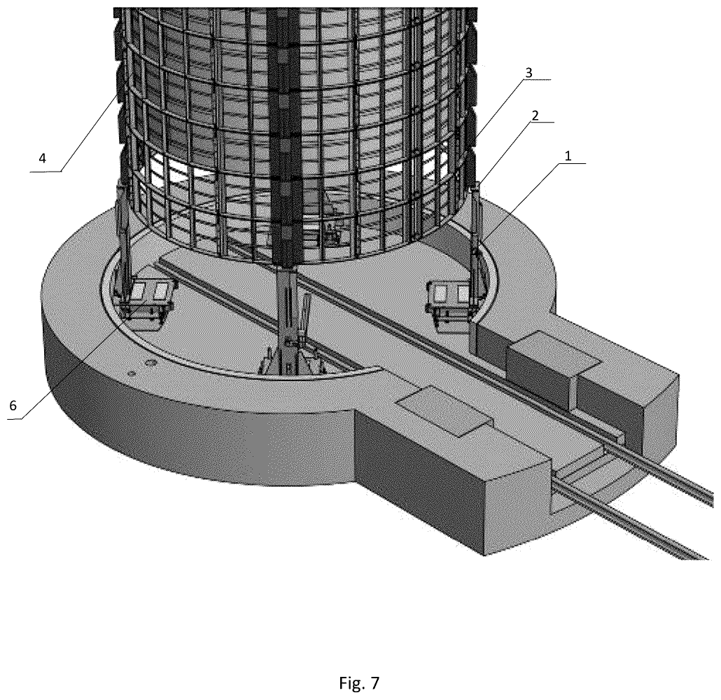

FIG. 7 shows general view of the reactor vessel outer heat insulation;

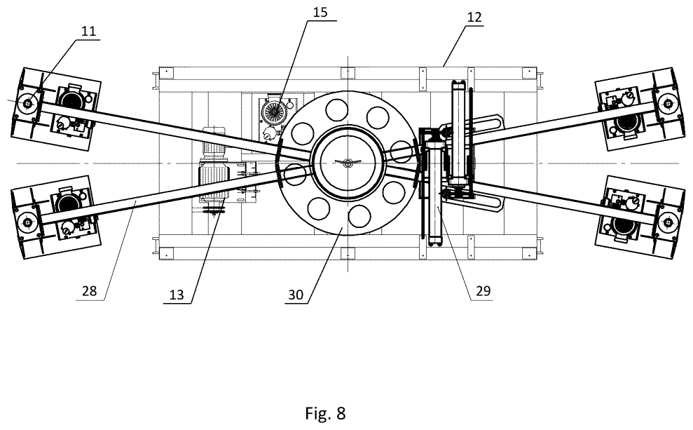

FIG. 8 shows a diagram of elevator installation device (top view) placed on the shuttle;

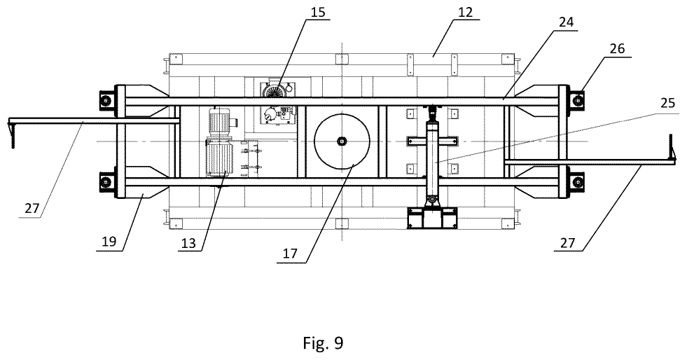

FIG. 9 shows a diagram of rack installation device (top view) placed on the shuttle;

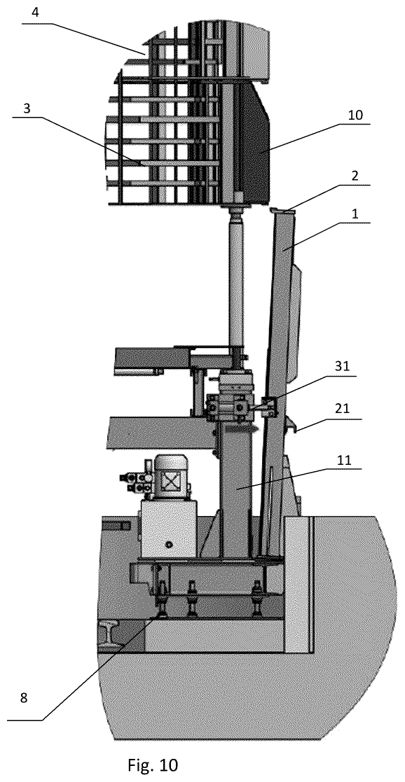

FIG. 10 shows the position (deflection) of racks when dismantling rings.

The outer heat insulation of the nuclear reactor vessel includes racks 1 mounted in series on top of each other on the upper support platforms 2 of racks 1, and support rings 3 and heat insulation rings 4 enveloping the nuclear reactor vessel. Racks 1 are evenly installed on the floor under the reactor in a circle, which is the projection of the support rings 3 or heat insulation rings 4 on the floor under the reactor. Each rack 1 is equipped with guide channels 5, made on the upper part of the inner rack surface 1. The racks 1 are hinged to the rack 1 bases 6, and the hinge 7 of the joint between the rack 1 and the base 6 of the rack 1 is offset relative to the center of gravity of the rack 1 with the possibility of deflecting the rack 1 from the vertical position and its self-returning to the vertical position. The base 6 of the rack 1 is equipped with an adjustable screw support 8 and has a support platform 9.

Support rings 3 and heat insulation rings 4 consist of articulated sections of frame structure (FIG. 3), made in the form of arched sections of the ring. Heat insulation made of mullite-silica felt is fixed on the inner side of the frame of each section of the heat insulation ring 4.

Support casings are made on the outer side of the frame sections of support rings 3 and heat insulation rings 4 adjacent to the racks 1.

To eliminate the exposure of operating personnel to ionizing radiation, it is proposed to install the outer heat insulation of the nuclear reactor vessel using a system of installation of the outer heat insulation of the nuclear reactor vessel.

The system of outer reactor vessel heat insulation installation includes the outer reactor vessel heat insulation described above, hoists 11 and a mobile shuttle 12 with replacement mounting equipment.

The mobile shuttle 12 is equipped with a mechanism for controlling the replacement installation equipment, a travel drive 13 of the shuttle 12, limit switch 14 for the shuttle 12 travel, a pumping station 15 and a hydraulic jack 16 with a rotating disk 17 mounted on the rod of the jack 16 connected to the pumping station 15, placed in the center of the shuttle 12.

Replacement mounting equipment includes a device 18 for the installation of racks 1, a device 19 for the installation of elevators 11 and a device 20 for the installation of support rings 3 and heat insulation rings 4.

The system of outer reactor vessel heat insulation installation also includes four racks 1 installed evenly under the support rings 3 and the heat insulation rings 4 on the floor under the reactor. The bases 6 of racks 1 are equipped with an adjustable screw support 8 and the grip bracket 21 for articulation with the device 18 for racks 1 installation and has a support platform 2 for the installation of elevators 11.

Support rings 3 and heat insulation rings 4 of the outer reactor vessel heat insulation are made in the form of articulated sections of frame structure, made in the form of arched segments of the ring, that enable double folding the ring in a rectilinear-extended transport position and its unfolding in the form of a circle in the working position.

Support casings 10 are made on the outer side of the frame sections of support rings 3 and heat insulation rings 4 adjacent to the racks 1, interacting with the guide channels 5 of the racks 1 during the installation of rings 3 and 4.

Outside, on the frame of ring sections diametrically opposed in the working position, which are the first and last sections in the transport position of the ring, as well as on the frame of the two side sections opposed in the transport position of the ring, sleeves 22 are made, designed for articulation with the pins 23 of the device 20 for the installation of support rings 3 and heat insulation rings 4.

The device 18 for the installation of racks 1 includes a swiveling frame 24 fixed on the rotary disk 17 of the hydraulic jack 16 of the mobile shuttle 12, equipped with a hydraulic rotary mechanism 25, the safety catches 26 fixed at the ends of the swiveling frame 24 designed for articulation with the bracket grips 21 of the bases 6 of racks 1, and rods 27 designed for holding the racks 1.

The device 19 for the installation of hoists 11 includes rotary beams 28 equipped with a separation mechanism 29. The middle part of the rotary beams 28 has support hubs 30, installed to rotate on a swiveling disk 17 of hydraulic jack 16. Hoists 11 are fixed at the ends of the rotary beams 28, designed for the installation of support rings 3 and heat insulation rings 4, and hydraulic cylinders 31 of racks 1 deflection during the dismantling of support rings 3 and heat insulation rings 4. In another embodiment, the hydraulic cylinders 31 for deflecting the racks 1 when dismantling the support rings 3 and heat insulation rings 4 can be installed on the elevators 11.

Beam decking 32 for laying the support rings 3 and heat insulation rings 4 are fixed on the rotary beams 28.

The device 20 for the installation of support rings 3 and heat insulation rings 4 contains a frame 33 with decking 34 designed for laying the support ring 3 or heat insulation ring 4.

Vertical pins 23 are made at the end of the frame 33, designed to articulate with the bushings 22 of the first section of the ring in transport position. A mobile carriage 35 is installed at the opposite end of the frame 33 with a chain travel mechanism, which also has vertical pins 23 for articulation with the bushings 22 of the last section of the ring in transport position. In the middle part of the frame 33, there are hydraulic cylinders 36 designed to separate the two lateral sections of the ring opposed in transport position. The ends of the rods of hydraulic cylinders 36 also have vertical pins 23 for articulation with the sleeves 22 of the side sections of the ring.

The wheel pairs 37 of the mobile shuttle 12 are installed on the rail track laid under the reactor. The mobile shuttle 12 is equipped with a locking mechanism, and one wheel pair 37 of the shuttle 12 is driven.

The mechanism for controlling the replacement mounting equipment and the travel drive 13 of the shuttle 12 contains a control cabinet electrically connected to the drive 13 of the shuttle 12, the limit switch 14 of the shuttle 12, the pumping station 15 of the shuttle 12, the hydraulic jack 16 of the shuttle 12 and the hydraulic cylinders 36 of the replacement mounting equipment. The hydraulic cylinders 36 of the replacement mounting equipment in the operating position are hydraulically connected to the pumping station 15 of the shuttle 12.

To provide heat insulation in the upper part of the outer reactor vessel heat insulation adjacent to the reactor vessel support truss, heat insulation rollers 38 made of mullite-silica felt, which also has shock-absorbing properties, are additionally fixed on the upper surface of the sections of the upper heat insulation ring 4.

The system of outer reactor vessel heat insulation installation operates as follows.

The shuttle 12 is set on the rail track in the depot. The control cabinet is installed in its place and electrical connections are made between the cabinet and the shuttle 12. Device 18 for the installation of support racks 1 is placed on the swiveling disk 17 of the shuttle 12. In front and behind of the shuttle 12, racks 1 are placed so that when the racks 1 are lifted, there is articulation of safety catches 16 of the rotary frame 24 with grip brackets 21 of the bases 6 of racks 1 and bars 27. Then the hydraulic jack 16 of the shuttle 12 raises the device 18 for the installation of support legs 1 with the racks 1 above the floor level, while the racks 1 are hooking with the frame 24. Then the shuttle 12 is moved from the depot to the space under the reactor. After the limit switch 14 rests against the wall of the space under the reactor, the shuttle 12 stops exactly under the center of nuclear reactor pressure vessel. The frame 24 is rotated at an angle of 45° with respect to the rail track using the hydraulic rotary mechanism 25, and lowered using the hydraulic jack 16. The two support legs are lowered to the floor under the reactor space, and the safety catches 16 come out of the grip brackets 21. The pivoting frame 24 is returned to its original position and the shuttle 12 is returned from the space under the reactor to the depot. The above procedure is repeated for the installation of the second pair of racks 1 on the regular places under the reactor space, differing in that the frame 24 is rotated the other way at an angle of −45° relative to the rail track. The vertical position of the racks 1 is adjusted using the screw supports 8. After returning the shuttle 12 to the depot, the device 18 for the installation of support racks 1 is removed.

Then, the separation mechanism 29 is mounted on the shuttle 12, and device 19 for the installation of the elevators 11 is placed on the swiveling disk 17 of the shuttle 12, while the rotary beams 28 are in folded state. Then, the hydraulic jack 16 of the shuttle 12 is used to lift the swiveling disk 17 with the device 19 with elevators 11 above the floor, the separation mechanism 29 hooks the rotary beams 28. The shuttle 12 moves from the depot to the space under the reactor and automatically stops at a specified point by means of limit switches 14 of the shuttle travel. Rotary beams 28 are separated with the elevators 11 using the separation mechanism 29 at an angle that corresponds to the position of the previously installed racks 1. The device 19 with the elevators 11 is lowered using the hydraulic jack 16 of the shuttle 12, while the elevators 11 are installed on the supporting platforms 9 of racks 1, and the separation mechanism 29 unhooks from the rotary beams 28. The shuttle with the separation mechanism 29 returns to the depot. The separation mechanism 29 is removed from the shuttle 12.

Then the device 20 for the installation of support rings 3 and heat insulation rings 4 is installed on the shuttle 12.

The upper heat insulation ring 4 in rectilinear-extended transport position, with heat insulation rollers 38 made of mullite-silica felt additionally fixed on it, is placed on the deck 34 of the device 20 for the installation of supporting 3 and heat insulation rings. At the same time, bushings 22 of the upper heat insulation ring 4 are articulated with pins 23 of the device 20 for the installation of supporting 3 and heat insulation 4 rings. Shuttle 12 moves from the depot to the space under the reactor and stops under the center of nuclear reactor pressure vessel. Using the hydraulic cylinders 36, the upper heat insulation ring 4 is unfolded and fixed in this position. At the same time, the upper heat insulation ring 4 additionally rests on the decking 32 of the beam when deployed. Then the carriage 35 is moved until the upper heat insulation ring 4 is in working position, when the support casings 10 of the sectors of the upper heat insulation ring 4 are located above the rods of elevators 11. A holder is used to fix the upper heat insulation ring 4 in unfolded working position. The rods of elevators 11 lift the upper heat insulation ring 4. During the lifting of the upper heat insulation ring 4, the upper inclined part of the support casings 10 passes through the guide channel 5 of the racks 1 and deflects the racks 1 from the vertical, while the upper heat insulation ring 4 rises 21-32 mm above the support platforms 2 of racks 1, and the racks 1 returns to the vertical position due to the self-return property. The upper heat insulation ring 4 is lowered on the upper support platform 2 of racks 1, then the rods of elevators 11 are lowered to the original state. As a result, the upper heat insulation ring 4 is located on 4 racks 1. Then the carriage 35 and hydraulic cylinders 36 are returned to their original state and the shuttle 12 is moved to the depot.

Then the procedure is repeated for the remaining insulation 4 and support 3 rings. Each successive ring takes on the previous ring as it is lifted. The procedure is repeated until the outer reactor heat insulation is fully installed.

Then the shuttle 12 is returned to the depot and the device 20 for the installation of support rings 3 and heat insulation rings 4 is disassembled. Then the separation mechanism 29 is mounted on the shuttle 12, the shuttle 12 is moved to the space under the reactor, under the device 19 for the installation of elevators 11, and the separation mechanism 29 is unfolded. Then, the hydraulic jack 16 of the shuttle 12 is used to lift the swiveling disk 17 with the device 19 and elevators 11 above the floor, and the separation mechanism 29 hooks with the rotary beams 28. The separation mechanism 29 is used to fold the rotary beams 28, and the shuttle 12 is moved to the depot. Then the device 19 for the installation of elevators 11 are dismantled.

As a result, the outer reactor vessel heat insulation in the space under the reactor, including the racks 1 with the supporting 3 and heat insulation 4 rings installed.

To dismantle the outer reactor heat insulation, the device 19 with elevators 11 is re-installed in the space under the reactor. Then the device 20 for the installation of support rings 3 and heat insulation rings 4 is mounted on the shuttle 12 and moved into the space under the reactor. Then the hydraulic cylinders 36 are extended, the carriage 35 is extended and the rods of elevators 11 are lifted until touched with support casings 10 of the lower support 3 ring. Then, the rods of elevators 11 lift the rings 20-30 mm above the support platform 2 of the racks 1. As a result, the racks 1 are free from the rings' weight.

Then the hydraulic cylinders 31 of racks 1 deflection, located at the ends of the support beams 28 (or on the elevators 11, in another embodiment) are activated. As a result, the racks 1 deviate from the vertical position and lower the rings. During the lowering of the rings, the hydraulic cylinders 31 of racks 1 deflection automatically return to their original position and the racks 1, slipping on the support casings 10 of the lower ring, self-reset vertically and take the weight of the other rings. The support ring 3 is lowered onto the decking 34 of the device 20 for the installation of support 3 and heat insulation 4 rings, with the sleeves 22 of the support ring 3 articulating with the pins 23 of the device 20 for the installation of support 3 and heat insulation 4 rings. Then the holder, which fixes the supporting ring 3 in working open position, is dismantled; the supporting ring 3 is folded in rectilinear-extended transport position using the carriage 35 and hydraulic cylinders 36. The shuttle 12 is moved to the depot, and the support ring 3 is removed from it.

Then the above procedure is repeated until the complete dismantling of support rings 3 and heat insulation rings 4. The device 20 for the installation of support 3 and heat insulation 4 rings is removed from the shuttle. Then the device 19 is moved from the space under the reactor to install the hoists 11 and then the racks 1 using the device 18.

The use of the claimed invention group will ensure installation and dismantling of the outer VVER reactor pressure vessel heat insulation in the confined space under the reactor and at the increased levels of ionizing radiation, and the performance of work in an automated mode, which eliminates the exposure of the operating personnel to ionizing radiation. Heat insulation of the external reactor vessel surface will ensure reduction of the temperature gradient through the thickness of the nuclear reactor vessel, uniformity of the physical properties for its metal and welds as well as reduction of thermal impacts on the surrounding structures during recovery annealing of the welds and/or base metal of the VVER reactor vessel.

1. An outer heat insulation of a nuclear reactor vessel, including racks, support and heat insulation rings installed in series on top of each other on the upper support platforms of the racks and enveloping the nuclear reactor vessel, with the racks evenly placed under the supporting and heat insulation rings on the floor of the space under reactor, each rack is provided with guide channels made on the upper part of the inner surface of the rack, and pivoted on the rack base, while the joint between the rack and the rack base is offset relative to the center of gravity of the rack with the possibility of deflection of the rack from the vertical position and its self-return to the vertical position, and the rack base is equipped with an adjustable screw support and has a support platform.

2. An outer nuclear reactor vessel heat insulation according to claim 1 characterized in that supporting and heat insulation rings are made in the form of articulated sections of frame structure, made in the form of arched ring segments; heat insulation made of mullite-silica felt is fixed on the inner side of the frame of each heat insulation ring section; heat insulation rollers made of mullite-silica felt are additionally fixed on the upper surface of the upper insulation ring sections, and support casings are made on the outer side of the frame of the support and insulation ring sections adjacent to the racks.

3. An outer reactor vessel heat insulation installation system, including outer reactor vessel heat insulation, hoists and mobile shuttle with replacement mounting equipment, while the outer reactor vessel heat insulation contains racks installed on the floor of the space under the reactor, support and heat insulation rings installed in series on top of each other on the upper support platforms of the racks and enveloping the nuclear reactor vessel, the mobile shuttle is equipped with a mechanism for controlling the replacement mounting equipment and the shuttle travel drive, limit switch of the shuttle travel, a pumping station and a hydraulic jack connected to the pumping station placed in the center of the shuttle, with a rotating disk fixed to the jack rod, and the replacement mounting equipment includes a rack mounting device, a device for mounting the elevators and a device for mounting the support and heat insulation rings.

4. A system according to claim 3 characterized in that it includes four racks evenly mounted under the support and heat insulation rings on the floor of the space under the reactor, each rack is provided with guide channels made on the upper part of the inner rack surface, and is hinged to the rack base, while the joint between the rack and the rack base is offset relative to the center of gravity of the rack with the possibility of deflection of the rack from the vertical position and its self-return to the vertical position, and the rack base is equipped with an adjustable screw support and grip brackets for articulation with the rack installation device and has a support platform for the installation of elevators.

5. A system according to claim 3, characterized in that support and heat insulation rings of the outer nuclear reactor vessel heat insulation are made in the form of articulated sections of frame structure, made in the form of arched segments of the ring, that enables folding the ring in a rectilinear-extended transport position and its unfolding in the form of a circle in the working position, heat insulation made of mullite-silica felt is fixed on the inner side of the frame of each section of the heat insulation ring, heat insulation rollers made of mullite-silica felt are additionally fixed on the upper surface of the upper insulation ring sections for the heat insulation of the support truss of the nuclear reactor pressure vessel, and support casings are made on the outer side of the frame of the support and insulation ring sections adjacent to the racks that interact with the guide channels of the racks in the installation of rings, and bushings for the articulation with pins of the support and heat insulating rings installation device can be made outside on the frame of the sections diametrically opposed in the working position of the ring and being the first and last sections in the transport position of the ring, as well as on the frame of two side sections opposed in the transport position of the ring.

6. A system according to claim 3 characterized in that the rack installation device includes a rotary frame fixed on the swiveling disk of the hydraulic jack of the shuttle, equipped with a hydraulic rotatory mechanism, the safety catches fixed on the ends of the frame, designed for the articulation with the grip brackets of the racks' base, and the bars designed for holding the racks.

7. A system according to claim 3 characterized in that the elevator mounting device includes rotary beams equipped with a separation mechanism; there are supporting hubs in the middle part of the rotary beams, that can rotate on a swivel disc of a hydraulic jack; there are hydraulic elevators fixed at the ends of the rotary beams, designed for installation of supporting and insulation rings; and there are beam decks for laying of supporting and insulation rings fixed on the rotary beams.

8. A system according to claim 3 characterized in that the device for installation of supporting and insulating rings contains a frame with decking designed for laying of supporting or insulating ring; at the end of the frame there are vertical pins designed for articulation with bushings of the first ring section in the transport position of the ring, at the opposite end of the frame there is a mobile carriage with a traveling mechanism, which has vertical pins for articulation with bushings of the last ring section in the transport position; and in the middle part of the frame, there are hydraulic cylinders designed for extending the two opposed side sections in the transport position of the ring, the ends of hydraulic cylinders' rods have vertical pins for articulation with the bushings of the ring side sections.

9. A system according to claim 3 characterized in that the wheel pairs of the shuttle are installed on the rail track laid under the reactor, the shuttle can be equipped with a locking mechanism, and one wheel pair of the shuttle can be driven.

10. A system according to claim 3, characterized in that the control mechanism for the replacement mounting equipment and the shuttle travel drive contains a control cabinet electrically connected with the shuttle travel drive, the shuttle travel limit switch, the shuttle pump station, the hydraulic jack of the shuttle and the hydraulic cylinders of the removable mounting equipment.

11. A system according to claim 3 characterized in that the hydraulic cylinders of the replacement mounting equipment in the operating position are hydraulically connected to the pumping station of the shuttle.

12. A system according to claim 3 characterized in that it is equipped with hydraulic cylinders for deflecting the racks when removing the support and heat insulation rings, installed on the ends of rotary beams or on elevators.
